(19) United States
(12) Patent Application Publication
(10) Pub. No.: US 2012/0146901 A1
(43) Pub. Date: Jun. 14, 2012

(54) OPERATION CONTROL DEVICE, OPERATION CONTROL METHOD, AND INPUT DEVICE

(76) Inventors: Yoshihiro Ujiie, Osaka (JP); Susumu Kobayashi, Kyoto (JP); Masaki Yamauchi, Osaka (JP)

(21) Appl. No.: 13/390,789

(22) PCT Filed: Jun. 9, 2011
(86) PCT No.: PCT/JP2011/003277

§ 371 Date: Feb. 16, 2012

(30) Foreign Application Priority Data
Jun. 23, 2010 (JP) 2010-143210

(51) Int. Cl. G06F 3/033

(52) U.S. Cl. 345/157

(57) ABSTRACT

The present invention provides an operation control device for preventing an incorrect operation during a change in a holding pattern of an input device. The operation control device is an operation control device which controls an operation inputted into a grippable input device by a user, including: a grip state detection unit (103) configured to detect a first grip state which is a state in which the user is holding the input device; an orientation detection unit (106) configured to detect an orientation of the input device; a holding pattern determination unit (1107) configured to determine whether or not the user is changing a holding pattern of the input device by determining whether or not a combination of the first grip state and the orientation corresponds to a predetermined combination; and an operation control unit (108) configured to invalidate the operation inputted into the input device when it is determined that the user is changing a holding pattern of the input device and configured to validate the operation inputted into the input device when it is determined that the user is not changing a holding pattern of the input device.

### TECHNICAL FIELD

The present invention relates to operation control devices which control operations inputted into grippable input devices by users.

### BACKGROUND ART

In recent years, Consumer Electronics (CE) apparatuses such as televisions and Blu-ray Disc (BD) recorders have provided ways of use that are different from conventional TV viewing thanks to installation of network-ready applications and the like. Network-ready applications are applications such as video viewing and photo viewer using a network, for example. Operations by cross keys, numeric keys, enter keys, and the like on the existing remote controls do not allow users to enjoy sufficiently comfortable operations on the applications. Therefore, there is a growing need for a new input device.

As such a new input device, a remote control is being developed for providing users with a plurality of ways of holding by using a plurality of sensors. To commercialize this remote control, robustness needs to be enhanced to withstand practical use by an ordinary user and, in particular, an incorrect operation unintended by a user needs to be prevented. An incorrect operation can occur because a user's finger incorrectly touches an input unit at a time of a change in ways of holding, and an input operation different from a user's intention is performed.

In order to prevent the incorrect operation, an input device disclosed in Patent Literature 1 is an input device having a plurality of surfaces of touch panels and restricting an actually operable surface by determining an orientation of the input device when being operated. With this, the input device in Patent Literature 1 prevents the incorrect operation by contact with other surfaces.

### CITATION LIST

### [Patent Literature]

### [PTL 1]

Japanese Unexamined Patent Application Publication No. 2009-294928

### SUMMARY OF INVENTION

### Technical Problem

However, an incorrect operation can occur to even the input device in Patent Literature 1.

For example, there is a case where a user changes a holding pattern of an input device such as a remote control. At this time, an input device using a technique disclosed in Patent Literature 1 may prevent an incorrect operation by detecting an orientation of the input device and restricting an operable surface. However, there is a case where operation of a change in a holding pattern by a user is not actually completed even after an orientation of the input device is changed. In this case, a finger incorrectly touches the operable surface, resulting in a possibility that an input operation different from a user's intention is performed.

In other words, there is a possibility that an incorrect operation occurs even when an operable surface is restricted according to the orientation of the input device.

Therefore, the present invention is intended to provide an operation control device which prevents an incorrect operation during a change in a holding pattern of the input device.

### Solution to Problem

In order to solve the aforementioned problem, an operation control device according to the present invention is an operation control device which controls an operation inputted into a grippable input device by a user, the operation control device including: (i) a grip state detection unit configured to detect a first grip state which is a state in which the user is holding the input device; (ii) an orientation detection unit configured to detect an orientation of the input device; (iii) a holding pattern determination unit configured to determine whether or not the user is changing a holding pattern of the input device by determining whether or not a combination of the first grip state and the orientation corresponds to a predetermined combination; (iv) and an operation control unit configured to invalidate the operation inputted into the input device when it is determined that the user is changing a holding pattern of the input device, and configured to validate the operation inputted into the input device when it is determined that the user is not changing a holding pattern of the input device.

With this, an operation during a change in a holding pattern is invalidated. Therefore, the incorrect operation during a change in a holding pattern of the input device can be prevented.

Moreover, the grip state detection unit is configured to detect, before detecting the first grip state, a second grip state which is a state in which the user is holding the input device, the operation control device further includes a grip state change detection unit configured to detect a change from the second grip state to the first grip state, and the holding pattern determination unit is configured to determine whether or not the user is changing a holding pattern of the input device when the change is detected.

With this, when the way of holding the input device is changed, it is determined whether or not the input device is during a change in a holding pattern. Therefore, it is determined at an appropriate time whether or not the input device is during a change in a holding pattern.

Moreover, the holding pattern determination unit is configured to determine whether or not the user is changing a holding pattern of the input device when an amount of the detected change is greater than a predetermined amount.

With this, when a change in the way of holding is large, it is determined whether or not the input device is during a change in a holding pattern. Therefore, it is determined at a more appropriate time whether or not the input device is during a change in a holding pattern and unnecessary processing is reduced.

Moreover, the operation control device further includes a grip state storage unit configured to store grip state information that is information indicating the detected second grip state, wherein the grip state detection unit is configured to store the grip state information indicating the detected second grip state in the grip state storage unit, and the grip state change detection unit is configured to detect the change from the second grip state indicated by the grip state information stored in the grip state storage unit to the first grip state detected by the grip state detection unit.

With this, information about the grip state is accumulated as a history. Therefore, a change in the grip state can be detected more accurately.

Moreover, the holding pattern determination unit is configured to determine whether or not the user is changing a holding pattern of the input device by determining whether or not the combination of the first grip state and the orientation corresponds to the predetermined combination corresponding to an operation object operated by the operation inputted into the input device.

With this, it is determined, according to an operation object, whether or not the input device is during a change in a holding pattern.

Moreover, the holding pattern determination unit is configured to determine whether or not the user is changing a holding pattern of the input device by determining whether or not the combination of the first grip state and the orientation corresponds to the predetermined combination corresponding to an application program that is the operation object.

With this, it is determined, according to an application program, whether or not the input device is during a change in a holding pattern.

Moreover, the operation control device further includes an operation object switching detection unit configured to detect a switch of the operation object, wherein the holding pattern determination unit is configured to determine whether or not the user is changing a holding pattern of the input device when the switch is detected.

With this, when the operation object is switched, it is determined whether or not the input device is during a change in a holding pattern. When the operation object is switched, it is highly likely that the user changes a holding pattern of the input device. In such a case, an incorrect operation is prevented by determination on whether or not the input device is during a change in a holding pattern.

Moreover, the operation control device further includes (i) a determination condition storage unit configured to store the predetermined combination corresponding to the operation object, and (ii) an operation object switching detection unit configured to detect a switch of the operation object, and configured to update the predetermined combination stored in the determination condition storage unit such that the predetermined combination corresponds to the operation object obtained by the switch, wherein the holding pattern determination unit is configured to determine whether or not the user is changing a holding pattern of the input device by determining whether or not the combination of the first grip state and the orientation corresponds to the predetermined combination stored in the determination condition storage unit.

With this, a determination condition is updated according to an operation object. Then, use of the updated determination condition makes it possible to accurately determine whether or not the input device is during a change in a holding pattern.

Moreover, the operation control device further includes a determination condition receiving unit configured to receive the predetermined combination corresponding to the operation object, wherein the holding pattern determination unit is configured to determine whether or not the user is changing a holding pattern of the input device by determining whether or not the combination of the first grip state and the orientation corresponds to the predetermined combination received by the determination condition receiving unit.

With this, according to the received determination condition, it is determined whether or not the input device is during a change in a holding pattern. With this, a flexible determination can be realized.

Moreover, the holding pattern determination unit is configured to determine whether or not the user is changing a holding pattern of the input device when the predetermined combination is received.

With this, when the user is highly likely to change a holding pattern of the input device, it is determined whether or not the input device is during a change in a holding pattern.

Moreover, the holding pattern determination unit is configured to determine that the user is changing a holding pattern of the input device when the combination of the first grip state and the orientation corresponds to the predetermined combination of (i) a state in which the user is holding the input device with one hand and (ii) an orientation which is not suitable to operate the input device with the one hand.

With this, when the user holds the input device with one hand and an orientation of the input device is not suitable for operation with one hand, the operation is invalidated. Therefore, an incorrect operation can be prevented.

Moreover, the holding pattern determination unit is configured to determine that the user is changing a holding pattern of the input device when the combination of the first grip state and the orientation corresponds to the predetermined combination of (i) a state in which the user is holding, with the one hand, the input device formed in a shape of having a longer side and (ii) an orientation in which the longer side of the input device is horizontal with respect to a gravity direction.

With this, when the user is holding the input device with one hand and the input device is in a horizontal orientation, the operation is invalidated. In such a condition, the operation is difficult and it is highly likely that the user is during a change in a holding pattern of the input device. An incorrect operation can be prevented by invalidating the operation in such a condition.

Moreover, the holding pattern determination unit is configured to determine that the user is changing a holding pattern of the input device when the combination of the first grip state and the orientation corresponds to the predetermined combination of (i) a state in which the user is holding the input device with a right hand and (ii) an orientation which is not suitable to operate with the right hand.

With this, when the user is holding the input device with the right hand and an orientation of the input device is not suitable for operation with the right hand, the operation is invalidated. Therefore, an incorrect operation can be prevented.

Moreover, the holding pattern determination unit is configured to determine that the user is changing a holding pattern of the input device when the combination of the first grip state and the orientation corresponds to the predetermined combination of (i) a state in which the user is holding the input device with a right hand and (ii) an orientation which is not suitable to operate with the right hand.

With this, when the user is holding the input device with the left hand and an orientation of the input device is not suitable for operation with the left hand, the operation is invalidated. Therefore, an incorrect operation can be prevented.

Moreover, the holding pattern determination unit is configured to determine that the user is changing a holding pattern of the input device when the combination of the first grip state and the orientation corresponds to the predetermined combination of (i) a state in which the user is holding the input device with both hands and (ii) an orientation which is not suitable to operate the input device with the both hands.

With this, when the user is holding the input device with both hands and an orientation of the input device is not suitable for operation with both hands, the operation is invalidated. Therefore, an incorrect operation can be prevented.

Moreover, an operation control method according to the present invention is an operation control method of controlling an operation inputted into a grippable input device by a user, and the operation control method includes: detecting a grip state which is a state in which the user is holding the input device; detecting an orientation of the input device; determining whether or not the user is changing a holding pattern of the input device by determining whether or not a combination of the grip state and the orientation corresponds to a predetermined combination; and invalidating the operation inputted into the input device when it is determined that the user is changing a holding pattern of the input device while validating the operation inputted into the input device when it is determined that the user is not changing a holding pattern of the input device.

With this, the operation control device can be implemented as the operation control method.

Moreover, an integrated circuit according to the present invention is an integrated circuit for controlling an operation inputted into a grippable input device by a user, and the integrated circuit includes: (i) a grip state detection unit configured to detect a grip state which is a state in which the user is holding the input device; (ii) an orientation detection unit configured to detect an orientation of the input device; (iii) a holding pattern determination unit configured to determine whether or not the user is changing a holding pattern of the input device by determining whether or not a combination of the grip state and the orientation corresponds to a predetermined combination; and (iv) an operation control unit configured to invalidate the operation inputted into the input device when it is determined that the user is changing a holding pattern of the input device, and configured to validate the operation inputted into the input device when it is determined that the user is not changing a holding pattern of the input device.

With this, the operation control device can be implemented as an integrated circuit.

A program according to the present invention may be a program for causing a computer to execute the operation control method.

With this, the operation control method can be implemented as a program.

A storage medium according to the present invention may be a non-transitory computer-readable recording medium having a program recorded thereon for causing a computer to execute the operation control method.

With this, the program can be implemented as a storage medium.

Moreover, an input device is a grippable input device which controls an operation by a user and the grippable input device includes: (i) a grip state detection unit configured to detect a grip state which is a state in which the user is holding the input device; (ii) an orientation detection unit configured to detect an orientation of the input device; (iii) a holding pattern determination unit configured to determine whether or not the user is changing a holding pattern of the input device by determining whether or not a combination of the grip state and the orientation corresponds to a predetermined combination; and (iv) an operation control unit configured to invalidate the operation inputted into the input device when it is determined that the user is changing a holding pattern of the input device, and configured to validate the operation inputted into the input device when it is determined that the user is not changing a holding pattern of the input device.

With this, the operation control device can be implemented as an input device.

### Advantageous Effects of Invention

With the present invention, an operation during a change in a holding pattern is invalidated. Therefore, an incorrect operation of the input device during a change in a holding pattern can be prevented.

### BRIEF DESCRIPTION OF DRAWINGS

FIG. 1 is a schematic view showing an example of an input device and a display device according to Embodiment 1.

FIG. 2 is a schematic view showing an example in which the input device according to Embodiment 1 is vertically held.

FIG. 3 is a block diagram showing an example of a configuration of the input device according to Embodiment 1.

FIG. 4 is a table showing an example of a determination condition according to Embodiment 1.

FIG. 5 is a table showing an example of grip state information and time information which are stored in a grip state storage unit according to Embodiment 1.

FIG. 6 is a flowchart showing an example of operation of the operation control device according to Embodiment 1.

FIG. 7 is a table showing a first example of determination according to Embodiment 1.

FIG. 8 is a table showing a second example of determination according to Embodiment 1.

FIG. 9 is a schematic view showing an example of an input device and a display device according to Embodiment 2.

FIG. 10 is a block diagram showing an example of a configuration of the input device according to Embodiment 2.

FIG. 11 is a table showing an example of a determination condition according to Embodiment 2.

FIG. 12 is a flowchart showing an example of operation of the operation control device according to Embodiment 2.

FIG. 13 is a schematic view showing an example of an input device and a display device according to Embodiment 3.

FIG. 14 is a block diagram showing an example of configurations of the input device and the display device according to Embodiment 3.

FIG. 15 is a flowchart showing an example of operation of the operation control device according to Embodiment 3.

FIG. 16 is a block diagram showing an example of a configuration of an operation control device according to Embodiment 4.

### DESCRIPTION OF EMBODIMENTS

Hereafter, embodiments of an operation control device and an operation control method according to the present invention will be described with reference to the drawings.

### Embodiment 1

In the case of a change in a state in which a user is holding the input device (hereafter also referred to as grip state), an operation control device according to Embodiment 1 determines whether or not a present state is during operation or during a change in a holding pattern according to a grip state and an orientation of the input device. The operation control device according to Embodiment 1 controls an operation inputted into the input device according to the determined state.

It is noted that, here, the operation inputted into the input device is information inputted into the input device by the user and information to operate an operation object such as an application program. Therefore, a representation of an operation may be replaced with such a representation as operation information, instruction information, an input signal, or input information.

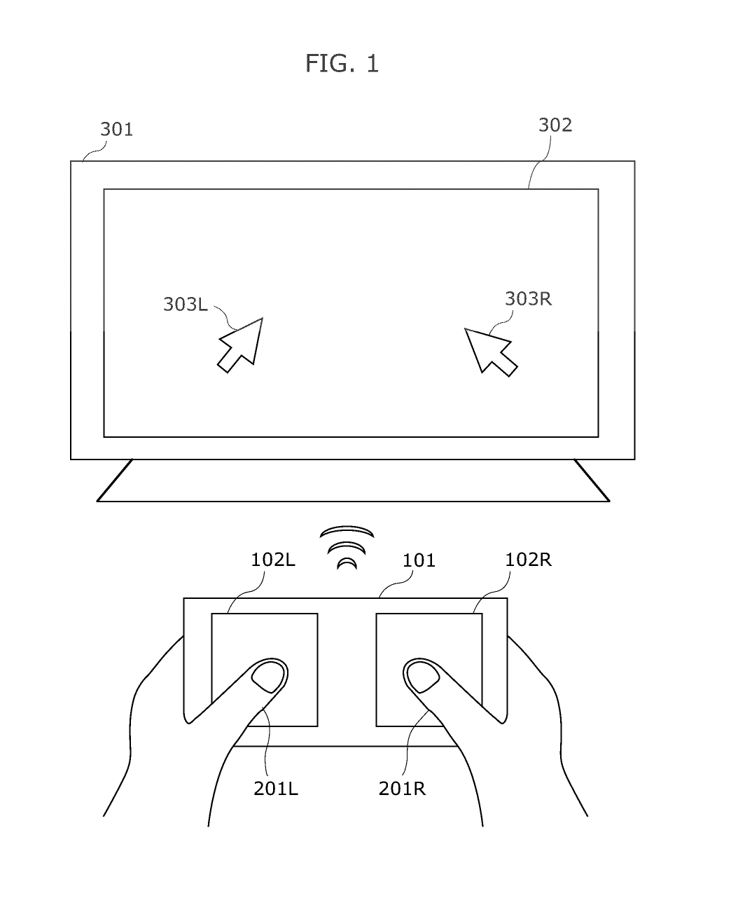

FIG. 1 is a schematic view showing an example of an input device and a display device according to Embodiment 1.

An input device 101 shown in FIG. 1 is an input interface device for inputting an operation into an operation object. The input device 101 includes two touch sensors (a left touch sensor 102L and a right touch sensor 102R), a grip sensor (not illustrated in FIG. 1), and an acceleration sensor (not illustrated in FIG. 1).

The left touch sensor 102L and the right touch sensor 102R are touched by a left finger 201L and a right finger 201R, respectively. With this, an operation for an application program displayed on a display screen 302 is inputted as an input signal. Moreover, each of the two touch sensors may detect not only a touch by a finger but also pressing in with a finger.

The input device 101 transmits input signals obtained by each the left touch sensor 102L and the right touch sensor 102R to a display device 301 by wireless communication. It is noted that the technique of detecting which portion of the input device 101 is touched by a finger by using an electrostatic pad as a touch sensor is publicly known, and thus a description thereof is omitted. Moreover, Bluetooth, ZigBee/IEEE802.15.4, and the like are used for wireless communication, but such wireless communication techniques are publicly known, and thus a description thereof is omitted here.

The signals transmitted by the input device 101 to the display device 301 includes a signal indicating a position at which a user's left finger 201L is touching the left touch sensor 102L and a signal indicating a position at which a user's right finger 201R is touching the right touch sensor 102R. Moreover, the transmitted signals include a signal which is obtained by the acceleration sensor and indicates an orientation of the input device 101 and a signal which is obtained by the grip sensor and indicates a portion where the user's hand is in touch with the input device 101.

A technique of measuring, by using the acceleration sensor, an orientation, in other words, an orientation of the input device 101, is publicly known, and thus a description thereof is omitted here. Moreover, a technique of detecting, by using the grip sensor, contact between a user's hand and the input device 101 is publicly known, and thus a description thereof is omitted here.

The display device 301 obtains, based on two signals indicating a position notified by the input device 101, position information about a point where the left finger 201L is in touch with the left touch sensor 102L and position information about a point where the right finger 201R is in touch with the right touch sensor 102R. The display device 301 displays a left cursor 303L and a right cursor 303R on positions which are corresponding to the obtained position information and which are in the display screen 302.

Moreover, the user operates the left cursor 303L displayed on the display screen 302 by moving the left finger 201L on the left touch sensor 102L. Moreover, the user operates the right cursor 303R displayed on the display screen 302 by moving the right finger 201R on the right touch sensor 102R.

A left half of a coordinate system of the entire screen display 302 is associated with a coordinate system of the left touch sensor 102L through absolute coordinates. Moreover, a right half of a coordinate system of the entire screen display 302 is associated with a coordinate system of the right touch sensor 102R through absolute coordinates.

For example, position information about each of the left touch sensor 102L and the right touch sensor 102R is represented by X-coordinates ranging from 0 to 400 and Y-coordinates ranging from 0 to 300, where an origin point (0, 0) is an end point at bottom left. Position information in the display screen 302 is indicated in X-coordinates ranging from 0 to 960 and Y-coordinates ranging from 0 to 540, where an origin point (0, 0) is an end point at bottom left.

In this case, the left half (an area with X-coordinates ranging from 0 to 480 and Y-coordinates ranging from 0 to 540) in the display screen 302 corresponds to the left touch sensor 102L and is an area where the left cursor 303L moves around. The right half (an area with X-coordinates ranging from 480 to 960 and Y-coordinates ranging from 0 to 540) corresponds to the right touch sensor 102R and is an area where the right cursor 303R moves around.

When the coordinate position on the left touch sensor 102L that is being touched by the user's left finger 201L is (200, 150), the coordinate position of the left cursor 303L displayed on the display screen 302 is (240, 270). When the coordinate position on the right touch sensor 102R that is being touched by the user's right finger 201R is (200, 150), the coordinate position of the right cursor 302R displayed on the display screen 302 is (720, 270).

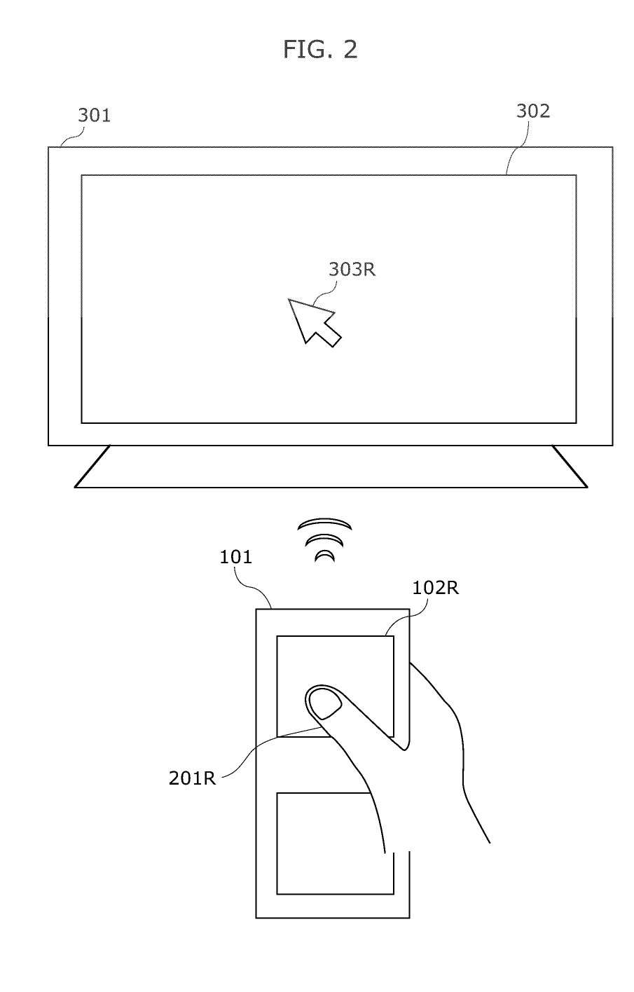

Moreover, when the user operates the input device 101 including the two touch sensors as shown in FIG. 1, there is a case where the input device 101 is operated by vertical holding instead of being operated by horizontal holding. Here, the horizontal holding, as shown in FIG. 1, is a state in which the user horizontally holds the input device 101 with both hands, operates the left touch sensor 102L with the left finger 201L, and operates the right touch sensor 102R with the right finger 201R. Moreover, the vertical holding, as shown in FIG. 2, is a state in which the user rotates an orientation of the input device 101 by 90 degrees, vertically holds the input device 101 with one hand, and operates the right touch sensor 102R with the right finger 201R, or operates the left touch sensor 102L with the left finger 201L. Moreover, the user can switch from horizontal holding to vertical holding even during operation of the input device 101. An operation by vertical holding will be described in detail with reference to FIG. 2.

It is noted that the input device 101 may rotate a logical direction by determining an orientation of the input device 101 and making assignments of the left and right touch sensors. With this, the user can operate the right touch sensor 102R with the left finger 201L or operate the left touch sensor 102L with the right finger 201R. In other words, the input device 101 may be operable upside down.

Moreover, also in the case of horizontal holding, by rotation of a logical direction of the input device 101, the user can operate the right touch sensor 102R with the left finger 201L and operate the left touch sensor 102L with the right finger 201R.

At this time, the display device 301 determines a grip state and an orientation based on a touch signal obtained through the grip sensor and an orientation signal obtained through the acceleration sensor, both of which are transmitted from the input device 101. In other words, the display device 301 determines a hand or hands (one of the left and right hands or both hands) holding the input device 101 and an orientation of the input device 101.

Moreover, the display device 301 determines, by using the determined hand or hands holding the determined input device 101 and the determined orientation of the input device 101, a position of a cursor displayed on the display screen 302 based on a signal indicating a position and a pressing-in signal both transmitted from the input device 101.

FIG. 2 is a schematic view showing an example in which the input device 101 shown in FIG. 1 is vertically held. In FIG. 2, the same reference signs are assigned to the same constituent elements as shown in FIG. 1, and a description thereof is omitted.

FIG. 2 shows an example in which the user vertically holds the input device 101 with only a right hand and operates the right touch sensor 102R with the right finger 201R. In this case, a cursor displayed on the display device 301 is only the right cursor 303R. In a coordinate system of the display screen 302, different from the case in FIG. 1, the coordinate system of the entire display screen 302 is associated with the coordinate system of the right touch sensor 102R through absolute coordinates.

For example, as similar to FIG. 1, position information in the display screen 302 is represented by X-coordinates ranging from 0 to 960 and Y-coordinates ranging from 0 to 540, where an origin point (0, 0) is an end point at bottom left. Moreover, the right touch sensor 102R shown in FIG. 2 is rotated 90 degrees in a left direction compared with the right touch sensor 102R shown in FIG. 1. Therefore, position information about the right touch sensor 102R is represented by X-coordinates ranging from 0 to 400 and Y-coordinates ranging from 0 to 300, where an origin point (0, 0) of the coordinates is an end point at bottom right.

In this case, the entire display screen 302 corresponds to the right touch sensor 102R and serves as an area where the right cursor 303R moves around. However, as mentioned above, the right touch sensor 102R shown in FIG. 2 is rotated 90 degrees in a left direction compared with the right touch sensor 102R shown in FIG. 1. Therefore, a corresponding relationship between coordinate systems is different. For example, when the coordinate position on the right touch sensor 102R that is being touched by the user's right finger 201R is (150, 200), the coordinate position of the right cursor 303R displayed on the display screen 302 is (480, 270).

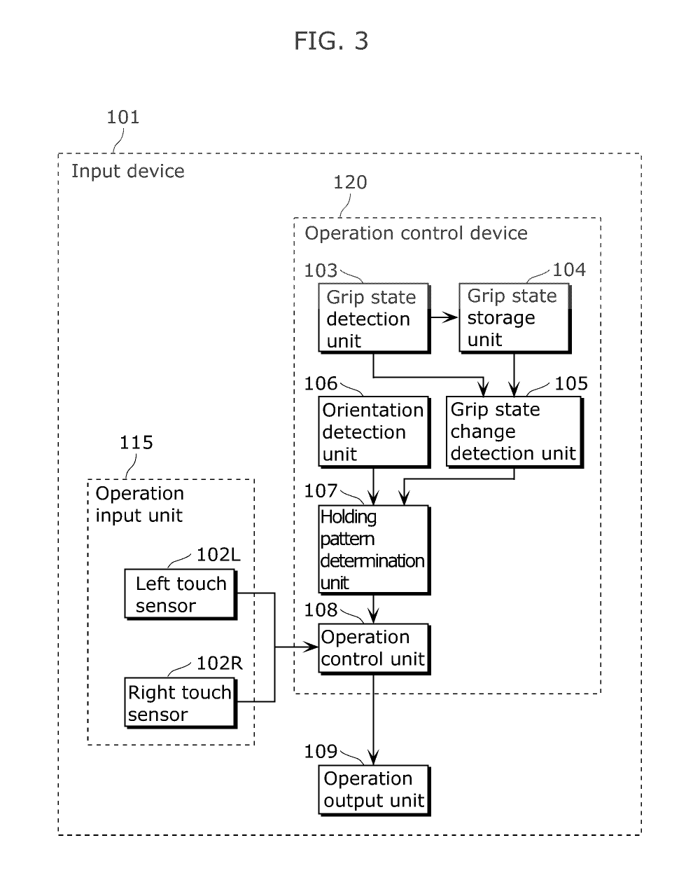

FIG. 3 is a schematic view showing an example of a configuration of the input device 101 shown in FIG. 1. In FIG. 3, the same reference signs are assigned to the same constituent elements as shown in FIG. 1 or FIG. 2, and a description thereof is omitted.

The input device 101 includes an operation input unit 115, an operation control device 120, and an operation output unit 109. The operation input unit 115 includes the left touch sensor 102L and the right touch sensor 102R. The operation control device 120 includes a grip state detection unit 103, a grip state storage unit 104, a grip state change detection unit 105, an orientation detection unit 106, a holding pattern determination unit 107, and an operation control unit 108.

The operation input unit 115 receives an operation inputted by the user. Then the operation input unit 115 notifies the operation control device 120 of the received operation as an input signal. In Embodiment 1, the left touch sensor 102L and the right touch sensor 102R receive an operation and notify the operation control unit 108 of the received operation as an input signal.

The grip state detection unit 103 is realized by a grip sensor, or the like, which detects a position of contact between the user and the input device 101. The grip state detection unit 103 detects, by detecting the contact position, a grip state which is a state in which the user is holding the input device 101. As a grip state, for example, there is a state in which the user is holding the input device 101 with both hands, one of the hands, a right hand, or a left hand. The grip state detection unit 103 may detect, as a grip state, a portion at which the user is holding the input device 101.

The grip state detection unit 103 stores, in the grip state storage unit 104, grip state information which is information indicating the detected grip state, together with time information which detects the grip state. Moreover, the grip state detection unit 103 notifies the grip state change detection unit 105 of the grip state information and the time information.

The grip state storage unit 104 stores grip state information. With this, a certain volume of grip information is accumulated.

The grip state change detection unit 105 detects a change in grip state according to the grip state information notified by the grip state detection unit 103 and the grip state information accumulated in the grip state storage unit 104. When a change in grip state is detected, the grip state change detection unit 105 notifies the holding pattern determination unit 107 of the grip state information notified by the grip state detection unit 103.

The orientation detection unit 106 is realized by the acceleration sensor, or the like, which detects an orientation of the input device 101. The orientation detection unit 106 detects an orientation of the input device 101. For example, the orientation of the input device 101 is a slope of the input device 101 with respect to a gravity direction.

More specifically, as the orientation of the input device 101, there is a horizontal direction as shown in FIG. 1 and a vertical direction as shown in FIG. 2. Moreover, when a configuration of the input device 101 is asymmetric, there is an upward direction, a downward direction, a right direction, a left direction, or the like as the orientation of the input device 101. Moreover, when the input device 101 is tilted in a forward direction or a backward direction, the orientation detection unit 106 may detect the forward direction or the backward direction as the orientation of the input device 101.

The orientation detection unit 106 notifies the holding pattern determination unit 107 of orientation information indicating the detected orientation.

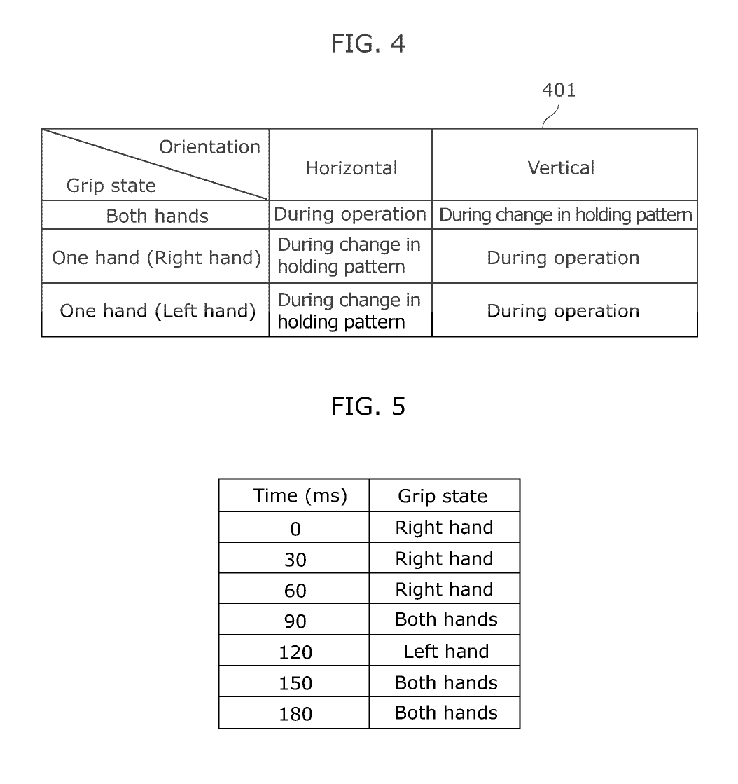

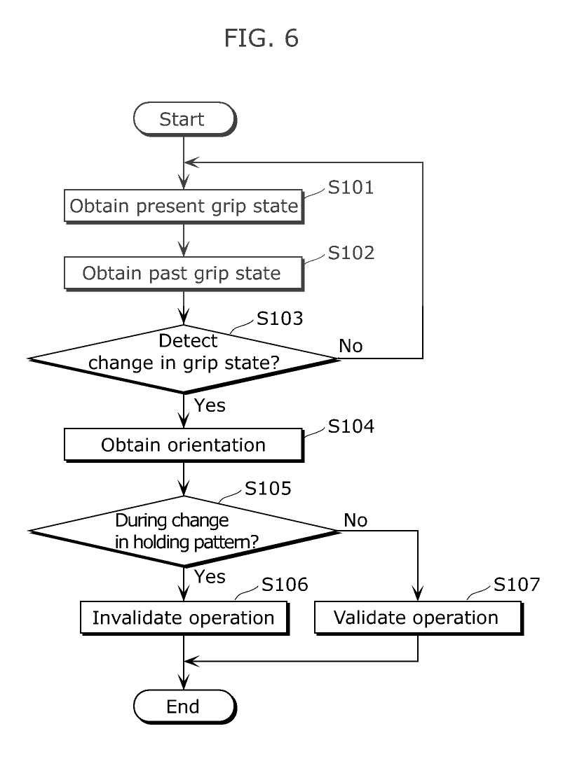

The holding pattern determination unit 107 determines whether or not the present operation state is during operation or during a change in a holding pattern when grip state information is notified by the grip state change detection unit 105. At this time, the holding pattern determination unit 107 determines whether or not the present operation state is during operation or during a change in a holding pattern according to grip state information notified by the grip state change detection unit 105 and orientation information notified by the orientation detection unit 106. It is noted that how the holding pattern determination unit 107 specifically determines an operation state will be described later with reference to FIG. 4, FIG. 5, and FIG. 6.

The operation control unit 108 controls an input signal notified by the left touch sensor 102L and an input signal notified by the right touch sensor 102R according to an operation state determined by the holding pattern determination unit 107.

Specifically, when the holding pattern determination unit 107 determines that the input device 101 is during operation, the operation control unit 108 notifies the operation output unit 109 of the input signals without any change. With this, the operation control unit 108 validates the operation. When the holding pattern determination unit 107 determines that the input device 101 is during a change in a holding pattern, the operation control unit 108 does not notify the operation output unit 109 of the input signals. With this, the operation control unit 108 invalidates the operation.

The operation output unit 109 provides, to the display device 301, the input signals notified by the operation control unit 108. With this, the operation output unit 109 provides the operation inputted into the input device 101 to the display device 301 as the input signals.

It is noted that the grip state detection unit 103 may have a grip sensor to detect contact and may detect a grip state by receiving notification from an external grip sensor. Moreover, the grip sensor is an example, and the grip state detection unit 103 may detect a grip state by other means. Moreover, the orientation detection unit 106 may have an acceleration sensor to detect an orientation and may detect an orientation by receiving notification from an external acceleration sensor. Moreover, the acceleration sensor is an example, and the orientation detection unit 106 may detect a orientation by other means.

FIG. 4 is a table showing an example of a determination condition in the holding pattern determination unit 107 shown in FIG. 3.

In a determination condition 401 shown in FIG. 4, a vertical axis is a grip state detected in the grip state detection unit 103 and a horizontal axis is an orientation detected in the orientation detection unit 106. According to a combination of a grip state and an orientation, it is determined whether or not the present state is during a change in a holding pattern.

A state in which the grip state is both hands is a state of holding the input device 101 with both hands as shown in FIG. 1, while a state in which the grip state is a right hand is a state of holding the input device 101 with only a right hand as shown in FIG. 2. A state in which the grip state is a left hand is a state of holding the input device 101 with only a left hand.

In addition, a state in which an orientation is horizontal, as shown in FIG. 1, is a state in which the input device 101 has a long side on the top. A state in which an orientation is vertical, as shown in FIG. 2, is a state in which the input device 101 is rotated 90 degrees from a state of FIG. 1, and the input device has a short side on the top.

An example of the determination condition 401 shown in FIG. 4 shows that (i) a state in which the user holds the input device 101 with both hands and an orientation of the input device 101 is horizontal, (ii) a state in which the user holds the input device 101 with a right hand or a left hand and an orientation of the input device 101 is vertical are determined as during operation and that (iii) a state in which the user holds the input device 101 with both hands and an orientation of the input device 101 is vertical and (iv) a state in which the user holds the input device 101 with a right hand or a left hand and an orientation of the input device 101 is horizontal are determined as during a change in a holding pattern.

It is noted that the determination condition 401 shown in FIG. 4 is a combination of a grip state and an orientation for determining “during operation” and “during a change in a holding pattern”, but a combination for determining one of “during operation” and “during a change in a holding pattern” is also acceptable.

Moreover, the determination condition 401 shows both hands, a right hand, or a left hand as a grip state, but grip states may be sorted out in more detail according to cases. The grip state detection unit 103 detects such a grip state from a portion which is touched by the input device 101. Or, the grip state detection unit 103 may detect such a grip state from the portion which is touched by the input device 101.

FIG. 5 is a table showing an example of grip state information and time information stored in the grip state storage unit 104.

Time shown in FIG. 5 is a time when the grip state detection unit 103 detects a grip state.

An example in FIG. 5 shows that when time is at time points of 0 ms, 30 ms, 60 ms, 90 ms, 120 ms, 150 ms, and 180 ms, the input device 101 is being held with a right hand, a right hand, a right hand, both hands, a left hand, both hands, and both hands, respectively.

FIG. 6 is a flowchart showing an example of operation of the operation control device 120 shown in FIG. 3.

First, the grip state detection unit 103 obtains a present grip state by detecting a present grip state. Then, the grip state detection unit 103 stores, in the grip state storage unit 104, grip state information indicating the present grip state, together with the present time information. Moreover, the grip state detection unit 103 notifies the grip state change detection unit 105 of the grip state information and the time information (S101).

Next, the grip state change detection unit 105 obtains a past grip state by obtaining grip state information accumulated in the grip state storage unit 104 (S102). Here, the grip state change detection unit 105 refers to the latest grip state information among data obtained before times notified by the grip state detection unit 103.

Next, the grip state change detection unit 105 detects a change in grip state through comparing the present grip state indicated by the grip state information notified by the grip state detection unit 103 and the past grip state indicated by the grip state information accumulated in the grip state storage unit 104 (S103). When there is no change in grip state (No in S103), operation control is not changed, therefore, the grip state change detection unit 105 obtains grip state information again from the grip state detection unit 103 (S101).

When there is a change in grip state (Yes in S103), the grip state change detection unit 105 notifies the holding pattern determination unit 107 of a grip state detected by the grip state detection unit 103. Then, the orientation detection unit 106 detects an orientation (S104).

Next, the holding pattern determination unit 107 determines the present operation state of the input device 101 based on the grip state obtained by the grip state detection unit 103 and the orientation detected by the orientation detection unit 106 (S105). Specifically, the holding pattern determination unit 107 determines whether or not the present operation state is during operation or during a change in a holding pattern by using the determination condition 401 shown in FIG. 4. Then the holding pattern determination unit 107 notifies the operation control unit 108 of a determination result.

The operation control unit 108 controls an input signal according to the determination result notified by the holding pattern determination unit 107.

Specifically, when the determination result determined by the holding pattern determination unit 107 is during a change in a holding pattern (Yes in S105), the operation control unit 108 invalidates input information from the left touch sensor 102L and the right touch sensor 102R (S106). In other words, in this case, the operation control unit 108 does not provide an input signal from the operation input unit 115 to the operation output unit 109.

When the determination result is during operation (No in S105), the operation control unit 108 validates input information from the left touch sensor 102L and the right touch sensor 102R (S107). In this case, the operation control unit 108 provides an input signal from the operation input unit 115 to the operation output unit 109.

A sequence of processes shown in FIG. 6 will be described based on a specific example. Here will be described the case where the grip state is changed from an operation by vertical holding to an operation by horizontal holding.

An example shows (i) first, the case where a time when the grip state detection unit 103 detects a grip state is 60 ms, a grip state is a right hand, and an orientation is vertical, (ii) next, the case where a time when the grip state detection unit 103 detects a grip state is 90 ms, a grip state is both hands, and an orientation is vertical, and (iii) next, the case where a time when the grip state detection unit 103 detects a grip state is 120 ms, a grip state is a left hand, and an orientation is horizontal, and (iv) finally, the case where a time when the grip state detection unit 103 detects a grip state is 150 ms, a grip state is both hands, and an orientation is horizontal.

Moreover, what FIG. 5 indicates is used as grip state information accumulated in the grip state storage unit 104.

(i) First of all, the case will be shown where the time is 60 ms, the grip state is a right hand, and the orientation is vertical.

The grip state detection unit 103 stores the time (60 ms) and the grip state (right hand) in the grip state storage unit 104. Then, the grip state detection unit 103 notifies the grip state change detection unit 105 of the time (60 ms) and the grip state (right hand) (S101).

Next, the grip state change detection unit 105 obtains grip state information which is before the time (60 ms) notified by the grip state detection unit 103 and indicates the latest grip state (S102). The latest grip state information which is before the time (60 ms) notified by the grip state detection unit 103 shows that a time is 30 ms and a grip state is a right hand.

Next, the grip state change detection unit 105 detects a change in grip state (S103). Here, it is determined that there is no change by comparing the grip state (right hand) corresponding to the time (60 ms) with the grip state (right hand) corresponding to the time (30 ms). Therefore, the first processing (S101) is performed again by the grip state detection unit 103 (No in S103).

(ii) Next, the case will be shown where the time is 90 ms, the grip state is both hand, and the orientation is vertical.

The grip state detection unit 103 stores the time (90 ms) and the grip state (both hands) in the grip state storage unit 104. Moreover, the grip state detection unit 103 notifies the grip state change detection unit 105 of the time (90 ms) and the grip state (both hands) (S101).

Next, the grip state change detection unit 105 obtains grip state information which is before the time (90 ms) notified by the grip state detection unit 103 and indicates the latest grip state (S102). The latest grip state information which is before the time (90 ms) notified by the grip state detection unit 103 shows that a time is 60 ms and a grip state is a right hand.

Next, the grip state change detection unit 105 detects a change in grip state (S103). Here, it is determined that there is a change by comparing the grip state (both hands) corresponding to the time (90 ms) with the grip state (right hand) corresponding to the time (60 ms). Therefore, the grip state change detection unit 105 notifies the holding pattern determination unit 107 of the grip state (both hands) (Yes in S103).

Next, the holding pattern determination unit 107 obtains an orientation of the input device 101 from the orientation detection unit 106 (S104). Here, the orientation obtained from the orientation detection unit 106 is vertical.

Next, the holding pattern determination unit 107 determines an operation state of the input device 101 according to the grip state (both hands) notified by the grip state detection unit 103 and the orientation (vertical) obtained from the orientation detection unit 106 (S105). The determination condition 401 shown in FIG. 4 is used for determination. According to the determination condition 401, a combination of a grip state (both hands) and an orientation (vertical) is during a change in a holding pattern. Therefore, the holding pattern determination unit 107 determines that the present state is during a change in a holding pattern, thus notifying the operation control unit 108 of the present state (Yes in S105).

Next, the operation control unit 108 controls an input signal based on the operation state (during a change in a holding pattern) notified by the holding pattern determination unit 107. Because the present operation state is during a change in a holding pattern, the operation control unit 108 invalidates input signals from the left touch sensor 102L and the right touch sensor 102R and does not notify the operation output unit 109 of the input signals (S106).

(iii) Next, the case will be shown where the time is 120 ms, the grip state is a left hand, and the orientation is horizontal.

The grip state detection unit 103 stores the time (120 ms) and the grip state (left hand) in the grip state storage unit 104. Moreover, the grip state detection unit 103 notifies the grip state change detection unit 105 of the time (120 ms) and the grip state (left hand) (S101).

Next, the grip state change detection unit 105 obtains grip state information which is before the time (120 ms) notified by the grip state detection unit 103 and indicates the latest grip state (S102). The latest grip state information which is before the time (120 ms) notified by the grip state detection unit 103 shows that a time is 90 ms and a grip state is both hands.

Next, the grip state change detection unit 105 detects a change in grip state (S103). Here, it is determined that there is a change by comparing the grip state (left hand) corresponding to the time (120 ms) with the grip state (both hands) corresponding to the time (90 ms). Therefore, the grip state change detection unit 105 notifies the holding pattern determination unit 107 of the grip state (left hand).

Next, the holding pattern determination unit 107 obtains an orientation of the input device 101 from the orientation detection unit 106 (S104). Here, the orientation obtained from the orientation detection unit 106 is horizontal.

Next, the holding pattern determination unit 107 determines an operation state of the input device 101 based on the grip state (left hand) notified by the grip state detection unit 103 and the orientation (horizontal) obtained from the orientation detection unit 106 (S105). The determination condition 401 shown in FIG. 4 is used for determination. According to the determination condition 401, a combination of a grip state (left hand) and an orientation (horizontal) indicates “during a change in a holding pattern”. Therefore, the holding pattern determination unit 107 determines that the present operation state is during a change in a holding pattern, thus notifying the operation control unit 108 of the present operation state (Yes in S105).

Next, the operation control unit 108 controls input signals based on the operation state (during a change in a holding pattern) notified by the holding pattern determination unit 107. Because the present operation state is during a change in a holding pattern, the operation control unit 108 invalidates input signals from the left touch sensor 102L and the right touch sensor 102R and does not notify the operation output unit 109 of the input signals (S106).

(iv) Finally, the case will be shown where the time is 150 ms, the grip state is both hands, and the orientation is horizontal.

The grip state detection unit 103 stores the time (150 ms) and the grip state (both hands) in the grip state storage unit 104. Moreover, the grip state detection unit 103 notifies the grip state change detection unit 105 of the time (150 ms) and the grip state (both hands) (S101).

Next, the grip state change detection unit 105 obtains grip state information which is before the time (150 ms) notified by the grip state detection unit 103 and indicates the latest grip state (S102). The latest grip state information which is before the time (150 ms) notified by the grip state detection unit 103 shows that a time is 120 ms and a grip state is a left hand.

Next, the grip state change detection unit 105 detects a change in grip state (S103). Here, it is determined that there is a change by comparing the grip state (both hands) corresponding to the time (150 ms) with the grip state (left hand) corresponding to the time (120 ms).

Therefore, the grip state change detection unit 105 notifies the holding pattern determination unit 107 of the grip state (both hands) (Yes in S103).

Next, the holding pattern determination unit 107 obtains an orientation of the input device 101 from the orientation detection unit 106 (S104). Here, the orientation obtained from the orientation detection unit 106 is horizontal.

Next, the holding pattern determination unit 107 determines an operation state of the input device 101 based on the grip state (both hands) notified by the grip state detection unit 103 and the orientation (horizontal) obtained from the orientation detection unit 106 (S105). The determination condition 401 shown in FIG. 4 is used for determination. According to the determination condition 401, a combination of a grip state (both hands) and an orientation (horizontal) indicates “during operation”. Therefore, the holding pattern determination unit 107 determines that the present operation state is during operation, thus notifying the operation control unit 108 of the present operation state (No in S105).

Next, the operation control unit 108 controls input signals based on the operation state (during operation) notified by the holding pattern determination unit 107. Because the present operation state is during operation, the operation control unit 108 validates input signals from the left touch sensor 102L and the right touch sensor 102R and notifies the operation output unit 109 of the input signals (S107).

With this, the validation of an operation and the invalidation of an operation are switched based on an operation state determined in advance according to a grip state and an orientation. Therefore, the operation control device 120 can prevent an incorrect operation which is performed by an input operation different from the user's intention because the user's finger incorrectly touches a touch sensor when the user changes a holding pattern of the input device 101.

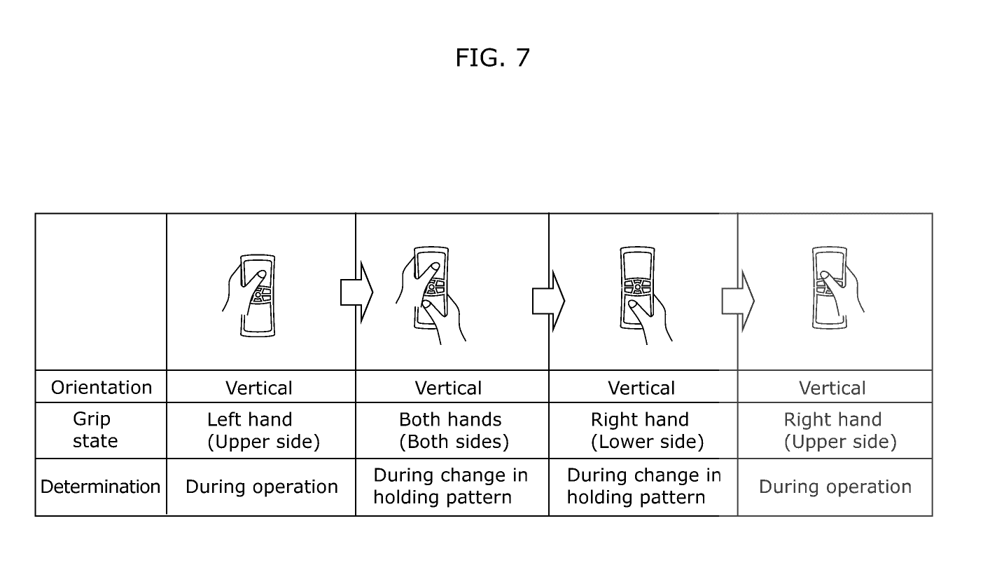

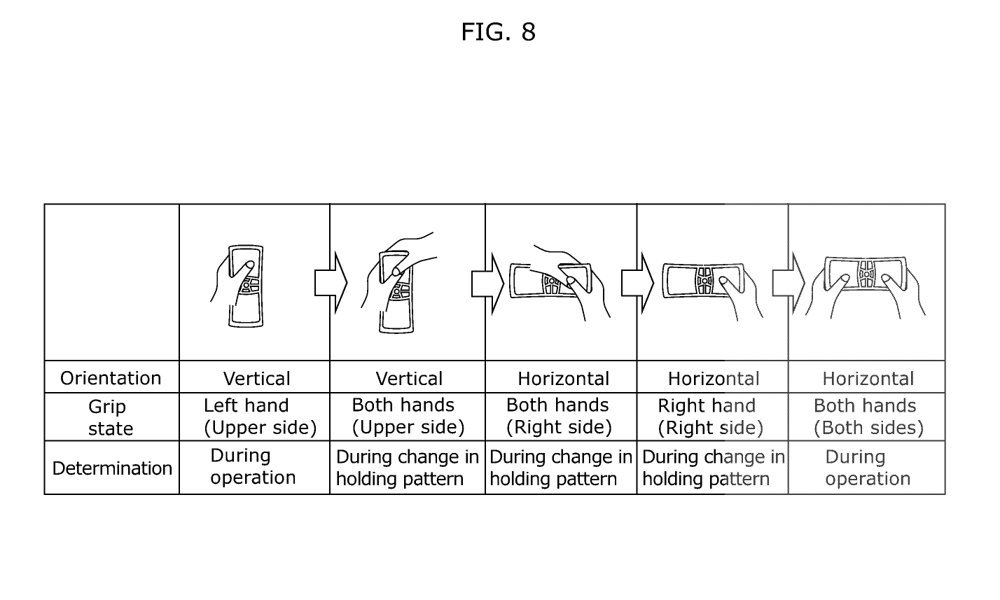

FIG. 7 and FIG. 8 are tables showing examples of results of determinations according to Embodiment 1.

In the examples shown in FIG. 7 and FIG. 8, when an orientation of the input device 101 is vertical and an upper side of the input device 101 is held with one hand, the holding pattern determination unit 107 determines that the user is operating the input device 101. Moreover, when an orientation of the input device 101 is horizontal and the grip state is a state in which both sides of the input device 101 is being held with both hands, the holding pattern determination unit 107 determines that the user is operating the input device 101.

When a combination of an orientation and a grip state is another combination, the holding pattern determination unit 107 determines that the user is changing a holding pattern of the input device 101.

The above described determination condition is determined in advance as in the case of the determination condition 401 shown in FIG. 4. Then, the holding pattern determination unit 107 determines, based on the predetermined determination condition, whether or not the user is changing a holding pattern of the input device 101.

In an example illustrated in FIG. 7, an orientation of the input device 101 is first vertical. A grip state is a state in which the user is holding an upper side of the input device 101 with a left hand. In this case, the holding pattern determination unit 107 determines, based on the predetermined determination condition, that the input device 101 is during operation. Then, the operation control unit 108 validates the operation.

Next, an orientation of the input device 101 is vertical. A grip state is a state in which the user is holding the input device 101 with both hands. In this case, the holding pattern determination unit 107 determines, based on the predetermined determination condition, that the input device 101 is during a change in a holding pattern. Then, the operation control unit 108 invalidates the operation.

Next, an orientation of the input device 101 is vertical. A grip state is a state in which the user is holding a lower side of the input device 101 with a right hand. In this case, the holding pattern determination unit 107 determines, based on the predetermined determination condition, that the input device 101 is during a change in a holding pattern. Then, the operation control unit 108 invalidates the operation.

Next, an orientation of the input device 101 is vertical. A grip state is a state in which the user is holding an upper side of the input device 101 with a right hand. In this case, the holding pattern determination unit 107 determines, based on the predetermined determination condition, that the input device 101 is during operation. Then, the operation control unit 108 validates the operation.

In an example illustrated in FIG. 8, an orientation of the input device 101 is first vertical. A grip state is a state in which the user is holding an upper side of the input device 101 with a left hand. In this case, the holding pattern determination unit 107 determines, based on the predetermined determination condition, that the input device 101 is during operation. Then, the operation control unit 108 validates the operation.

Next, an orientation of the input device 101 is vertical. A grip state is a state in which the user is holding the input device 101 with both hands. In this case, the holding pattern determination unit 107 determines, based on the predetermined determination condition, that the input device 101 is during a change in a holding pattern. Then, the operation control unit 108 invalidates the operation.

Next, an orientation of the input device 101 is horizontal. A grip state is a state in which the user is holding a right side of the input device 101 with both hands. In this case, the holding pattern determination unit 107 determines, based on the predetermined determination condition, that the input device 101 is during a change in a holding pattern. Then, the operation control unit 108 invalidates the operation.

Next, an orientation of the input device 101 is horizontal. A grip state is a state in which the user is holding the input device 101 with a right hand. In this case, the holding pattern determination unit 107 determines, based on the predetermined determination condition, that the input device 101 is during a change in a holding pattern. Then, the operation control unit 108 invalidates the operation.

Next, an orientation of the input device 101 is horizontal. A grip state is a state in which the user is holding both sides of the input device 101 with both hands. In this case, the holding pattern determination unit 107 determines, based on the predetermined determination condition, that the input device 101 is during operation. Then, the operation control unit 108 validates the operation.

In this way, based on a combination of an orientation and a grip state, it is determined whether or not the user is changing a holding pattern of the input device 101. Moreover, not only both hands and one hand but also which portion of the input device 101 is being held are used as a grip state. By detecting a detailed grip state, the operation control device 120 can more appropriately determine whether or not the input device 101 is during a change in a holding pattern.

Moreover, when a state during a change in a holding pattern and a state during operation are changed, at least a grip state is changed. Therefore, the operation control device 120 can more appropriately control operation to avoid an incorrect operation by determining whether or not the input device 101 is during a change in a holding pattern when a change in grip state is detected.

It is also possible that the holding pattern determination unit 107 specifies an amount of change in grip state and when the amount of change is greater than a predetermined amount, the holding pattern determination unit 107 determines whether or not the operation state is during a change in a holding pattern. Moreover, the amount of change in grip state may be specified from a change in a portion of contact. With this, when the change in grip state is large, it is determined whether or not the input device 101 is during a change in a holding pattern. Therefore, it can be determined at a more appropriate timing whether or not the input device 101 is during a change in a holding pattern.

Moreover, in a case of a change in a holding pattern, the operation control unit 108 according to Embodiment 1 invalidates an operation by avoiding notifying the operation output unit 109 of a signal indicating an operation inputted into the operation input unit 115. However, a method of invalidating an operation is not limited to such a method.

The operation control unit 108 may invalidate an operation by controlling the operation input unit 115 such that the operation input unit 115 does not receive an input from the user. Or, the operation control unit 108 may invalidate an operation by causing the operation output unit 109 to transmit, to the display device 301, a state in which the input device 101 is in a state of invalidation.

### Embodiment 2

An operation control device according to Embodiment 2 determines whether or not a present operation state is during operation or during a change in a holding pattern when a grip state is changed or an operation object is switched which is operated by an operation inputted into an input device. At this time, the operation control device determines, according to a grip state, an orientation of the input device, and a determination condition determined in advance according to an operation object, whether or not the present operation state is during operation or during a change in a holding pattern. Then, according to the determined operation state of the input device, the operation control device controls the operation inputted into the input device.

An operation object is typically an application program and is displayed on a display device. For example, the operation object is an application program that a user operates by using Graphical User Interface (GUI) and the like. Furthermore, the user can switch the application program that is the operation object by using GUI and the like.

A determination condition is determined in advance according to an operation object. For example, there is a case where a grip state of a right hand, a left hand, or the like, and an orientation of an input device are technically determined in advance in a video game or a medical application program. The operation control device according to Embodiment 2 uses such a condition as a determination condition for “during a change in a holding pattern”.

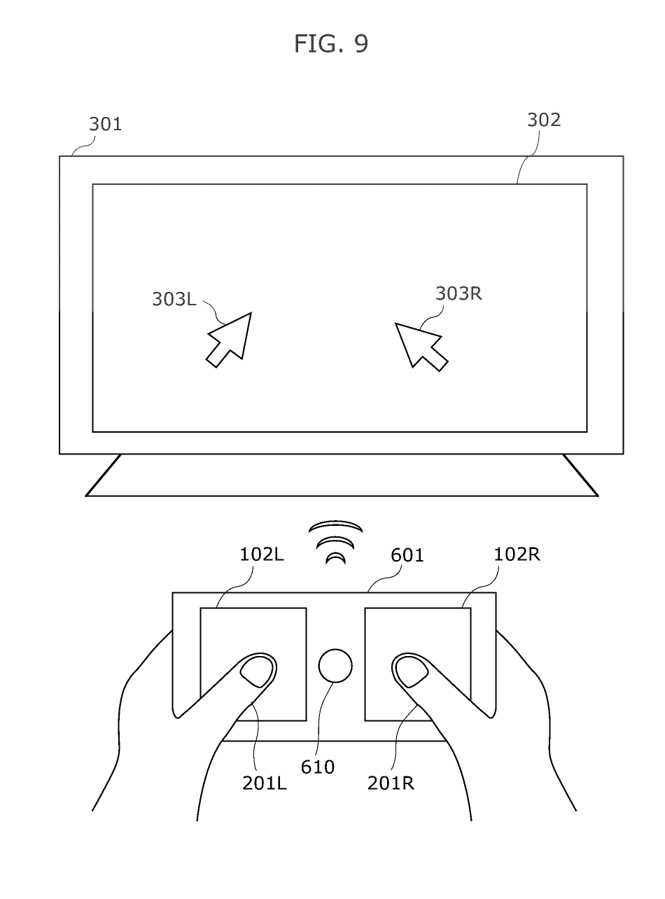

FIG. 9 is a schematic view showing an example of an input device and a display device according to Embodiment 2. In FIG. 9, the same reference signs are assigned to the same constituent elements as shown in FIG. 1, and a description thereof is omitted.

An input device 601 shown in FIG. 9 includes, as similar to the input device 101 as shown in Embodiment 1, two touch sensors (the left touch sensor 102L and the right touch sensor 102R), the grip sensor (not illustrated in FIG. 9), and the acceleration sensor (not illustrated in FIG. 9).

An operation is inputted into each the left touch sensor 102L and the right touch sensor 102R by the left finger 201L and the right finger 201R, respectively. The input device 601 transmits signals obtained by the left touch sensor 102L and the right touch sensor 102R to the display device 301 by wireless communication.

It is noted that the signals transmitted to the display device 301 by the input device 601 include a signal indicating a position at which the user's left finger 201L is touching the left touch sensor 102L and a signal indicating a position at which the user's right finger 201R is touching the right touch sensor 102R. The transmitted signals may include a signal indicating an orientation of the input device 601 obtained through the acceleration sensor, and a signal, obtained through the grip sensor, which indicates contact of a hand of the user with the input device 601.

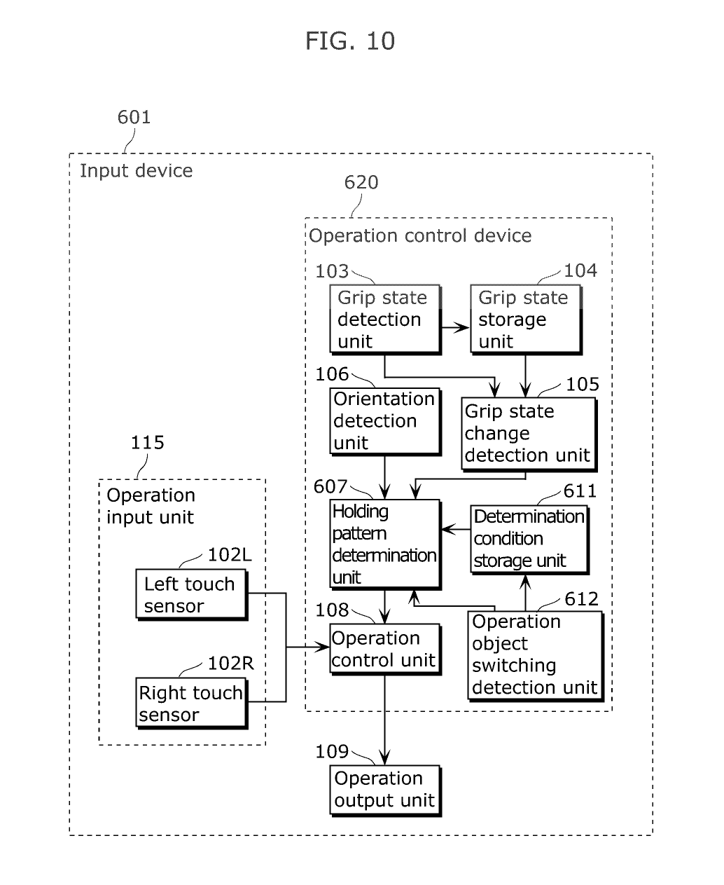

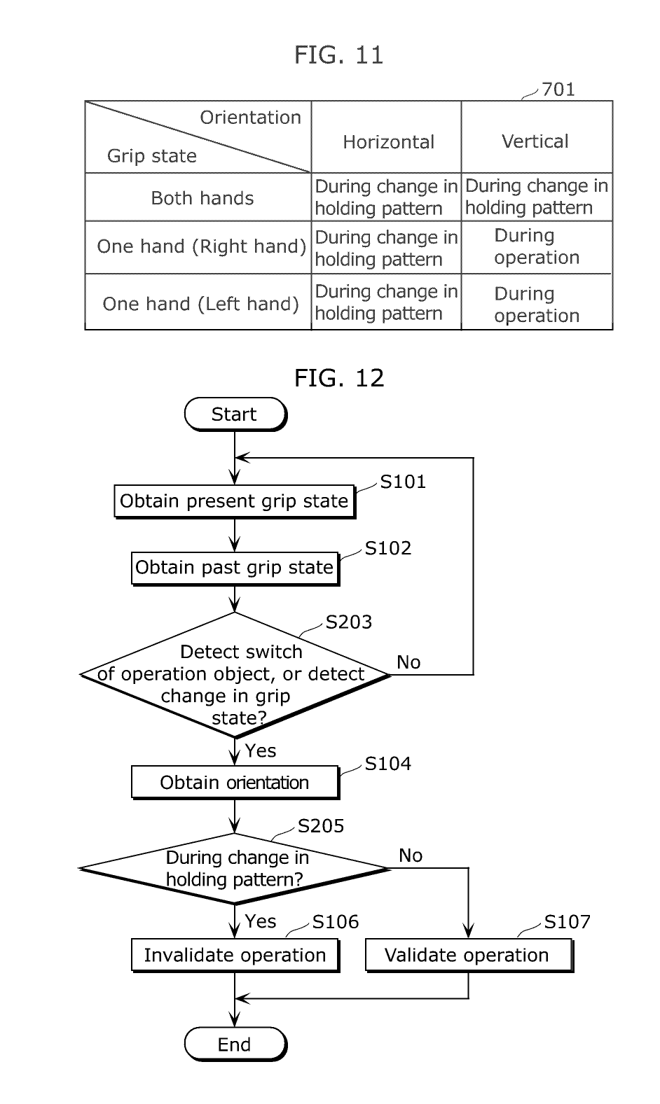

Furthermore, the input device 601 includes a switch 610 for changing a determination condition according to an application program displayed on the display screen 302. The switch 610 is an example of the operation object switching detection unit and is pressed down to detect a switch of an operation object. A specific operation by the switch 610 will be described in detail with reference to FIG. 10, FIG. 11, and FIG. 12.

FIG. 10 is a block diagram showing an example of a configuration of the input device 601 shown in FIG. 9. In FIG. 10, the same reference signs are assigned to the same constituent elements as shown in FIG. 3 or FIG. 9, and a description thereof is omitted.

An operation control device 620 shown in FIG. 10 is different from the operation control device 120 shown in Embodiment 1 in that the operation control device 620 includes an operation object switching detection unit 612 and a determination condition storage unit 611. Moreover, operation of a holding pattern determination unit 607 is changed.

The determination condition storage unit 611 stores a determination condition. The determination condition will be described in detail later with reference to FIG. 11.

The operation object switching detection unit 612, embodied by the switch 610 and the like, detects a switch of an operation object. The user switches the switch 610 by a hand of the user when the application program that is the operation object is switched. With this, the operation object switching detection unit 612 detects the switch of the operation object and the determination condition stored in the determination condition storage unit 611 is updated to a determination condition according to an operation object.

It is noted that the operation object switching detection unit 612 may have the switch 610 and may detect a switch of an operation object by receiving notification from an external switch. Moreover, the switch 610 is an example and the operation object switching detection unit 612 may detect a switch of an operation object by other means. For example, the operation object switching detection unit 612 may detect a switch of an operation object by receiving information indicating a switch of an operation object from the display device 301.

The holding pattern determination unit 607 determines the present operation state of the input device 601 when the grip state change detection unit 105 detects a change in grip state or when the operation object switching detection unit 612 detects a switch of an operation object. At this time, the holding pattern determination unit 607 determines the present operation state of the input device 601 according to a grip state detected by the grip state detection unit 103 and an orientation detected by the orientation detection unit 106. Then, the holding pattern determination unit 607 notifies the operation control unit 108 of the determined operation state. A method of determining an operation state of the input device 601 will be described in detail later with reference to FIG. 12.

FIG. 11 is a table showing an example of a determination condition in the holding pattern determination unit 607 shown in FIG. 10.

In a determination condition 701 shown in FIG. 11, a vertical axis is a grip state detected by the grip state detection unit 103 and a horizontal axis is an orientation detected by the orientation detection unit 106. According to a combination of an orientation and a grip state, it is determined whether or not the present state is during a change in a holding pattern.

Moreover, the determination condition 701 is prepared according to all application programs operated by the input device 601. Then the determination condition 701 is changed every time the switch 610 is pressed down.

An example of the determination condition 701 shown in FIG. 11 shows that (i) a state in which the user is holding the input device 601 with a right hand or a left hand and an orientation of the input device 601 is vertical is determined as “during operation”, while a state in each of which (ii) the user is holding the input device 601 with both hands and the orientation of the input device 601 is horizontal, (iii) the user is holding the input device 601 with both hands and the orientation of the input device 601 is vertical, and (iv) the user is holding the input device 601 with a right hand or a left hand and the orientation of the input device 601 is horizontal is determined as “during a change in a holding pattern”.

FIG. 12 is a flowchart showing an example of operation of the operation control device 620 shown in FIG. 10. In FIG. 12, the same reference signs are assigned to the same processes as shown in FIG. 6, and a description thereof is omitted.

First, the grip state detection unit 103 detects a present grip state. Then, the grip state change detection unit 105 obtains the present grip state from the grip state detection unit 103 (S101). Moreover, the grip state change detection unit 105 obtains a past grip state from the grip state storage unit 104 (S102).

Then, the grip state change detection unit 105 detects a change in grip state by using the present grip state obtained from the grip state detection unit 103 and the past grip state obtained from the grip state storage unit 104. The above mentioned processing is performed as similarly to the processing in Embodiment 1. In Embodiment 2, whether or not the input device 601 is during a change in a holding pattern is determined in both when a change in grip state is detected and when an operation object is switched.

When an operation object displayed on the display screen 302 is switched, the user presses down the switch 610. With this, the operation object switching detection unit 612 detects a switch of the operation object. In the operation object switching detection unit 612, the determination condition stored in the determination condition storage unit 611 is updated to the determination condition 701 corresponding to the operation object. Then, the operation object switching detection unit 612 notifies the holding pattern determination unit 607 that the operation object is switched.

Then, the holding pattern determination unit 607 determines whether or not a grip state is changed and the operation object is switched (S203).

Because, when there is no change in grip state or the operation object is not switched (No in S203), an input signal is not controlled, the above mentioned processing will be repeated until the occurrence of a change in grip state or a switch of the operation object.

When there is a change in grip state or an operation object is switched (Yes in S203), the orientation detection unit 106 detects an orientation (S104). The holding pattern determination unit 607 obtains the orientation detected by the orientation detection unit 106.

Next, the holding pattern determination unit 607 determines the present operation state of the input device 601 based on a grip state detected by the grip state detection unit 103, an orientation detected by the orientation detection unit 106, and the determination condition 701 stored in the determination condition storage unit 611 (S205). Specifically, the holding pattern determination unit 607 determines the present operation state by using the determination condition 701 shown in FIG. 11.

When the present state is during a change in a holding pattern (Yes in S205), the operation control unit 108 invalidates the operation (S106). When the present state is during operation (No in S205), the operation control unit 108 validates the operation (S107).

A sequence of processes shown in FIG. 12 will be described based on a specific example. Here is an example in which the switch 610 is operated at a time 180 ms and the determination condition 401 is updated to the determination condition 701 corresponding to an operation object that has been switched. The first will show the case where a time is 150 ms, a grip state is both hands, and an orientation is horizontal, and the next will show the case where a time is 180 ms, a grip state is both hands, and an orientation is horizontal. Moreover, the following will show the case where what FIG. 5 describes is accumulated in the grip state storage unit 104.

The first will show the case where a time is 150 ms, a grip state is both hands, and an orientation is horizontal.

The grip state detection unit 103 stores the time (150 ms) and the grip state (both hands) in the grip state storage unit 104. Moreover, the grip state detection unit 103 notifies the grip state change detection unit 105 of the time (150 ms) and the grip state (both hands) (S101).

Next, the grip state change detection unit 105 obtains the latest grip state information which is before the time (150 ms) notified by the grip state detection unit 103 (S102). The latest grip state information which is before the time (150 ms) notified by the grip state detection unit 103 shows that a time is 120 ms and a grip state is a left hand.

Next, the grip state change detection unit 105 detects a change in grip state (S203). Here, the existence of a change is determined through comparing the grip state (both hands) corresponding to the time (150 ms) with the grip state (left hand) corresponding to the time (120 ms). Therefore, the grip state change detection unit 105 notifies the holding pattern determination unit 607 of the grip state (both hands).

Next, the holding pattern determination unit 607 obtains an orientation of the input device 601 from the orientation detection unit 106 (S104). Here, the orientation obtained from the orientation detection unit 106 is horizontal.

Next, the holding pattern determination unit 607 determines an operation state of the input device 601 according to a grip state (both hands) detected by the grip state detection unit 103 and an orientation (horizontal) detected by the orientation detection unit 106 (S205). The determination condition 401 shown in FIG. 4 is used for determination. According to the determination condition 401, a combination of the grip state which is both hands and the orientation which is horizontal indicates “during operation”. Therefore, the holding pattern determination unit 607 determines that the present operation state is during operation, thus notifying the operation control unit 108 of the present operation state (No in S205).

Next, the operation control unit 108 controls input signals according to the operation state (during operation) notified by the holding pattern determination unit 607. Because the present operation state is during operation, the operation control unit 108 validates input signals from the left touch sensor 102L and the right touch sensor 102R, notifying the operation output unit 109 of the input signals (S107).

Next, at the time of 180 ms when the operation object is switched and the switch 610 is pressed down, the operation object switching detection unit 612 detects a switch of the operation object. Then, in the operation object switching detection unit 612, the determination condition 401 stored in the determination condition storage unit 611 is updated to the determination condition 701 corresponding to an operation object that has been switched.

When a switch of an operation object is detected (Yes in S203), the orientation detection unit 106 detects an orientation (S104).

Next, the holding pattern determination unit 607 determines an operation state of the input device 601 according to a grip state (both hands) detected by the grip state detection unit 103 and an orientation (horizontal) detected by the orientation detection unit 106 (S205). The determination condition 701 shown in FIG. 11 is used for determination. According to the determination condition 701, a combination of a grip state which is both hands and an orientation which is horizontal indicates “during a change in a holding pattern”. Therefore, the holding pattern determination unit 607 determines that the present operation state is during operation, thus notifying the operation control unit 108 of the present operation state (No in S205).

Next, the operation control unit 108 controls input signals according to the operation state (during a change in a holding pattern) notified by the holding pattern determination unit 607. Because the present operation state is during a change in a holding pattern, the operation control unit 108 invalidates input signals from the left touch sensor 102L and the right touch sensor 102R and does not notify the operation output unit 109 of the input signals (S106).

With this, by setting a determination condition according to an operation object, the operation control device 620 can prevent an incorrect operation caused by execution of an input operation different from a user's intention as a result of a touch sensor being incorrectly touched by a finger when a way of holding is changed.

### Embodiment 3

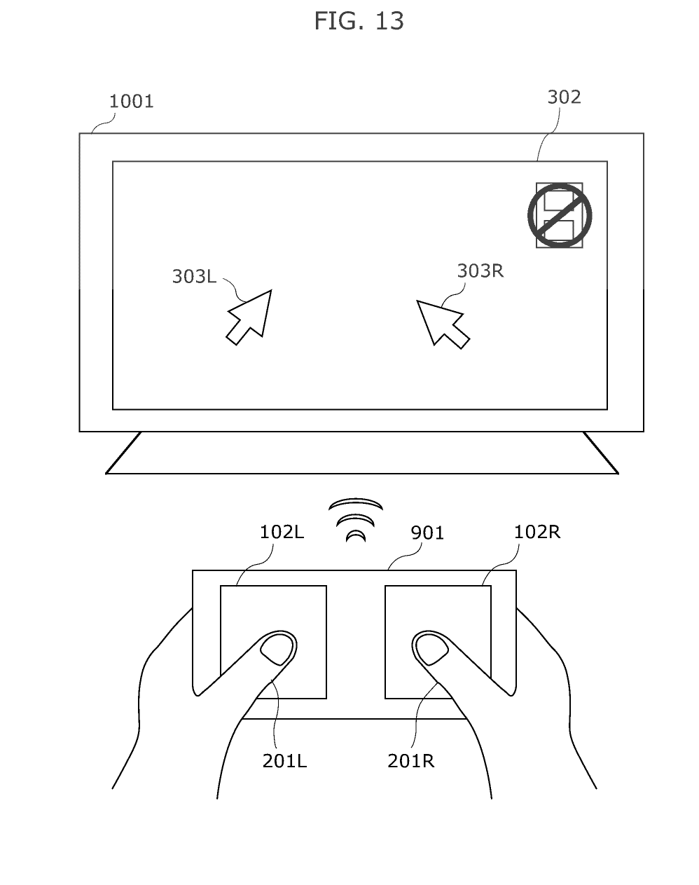

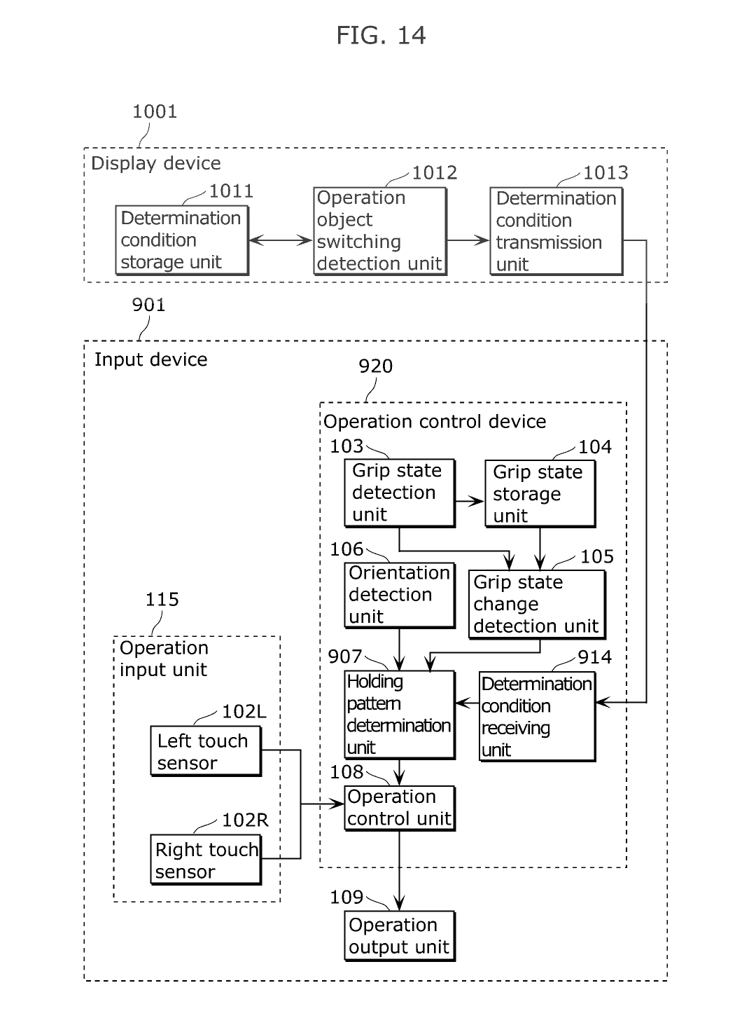

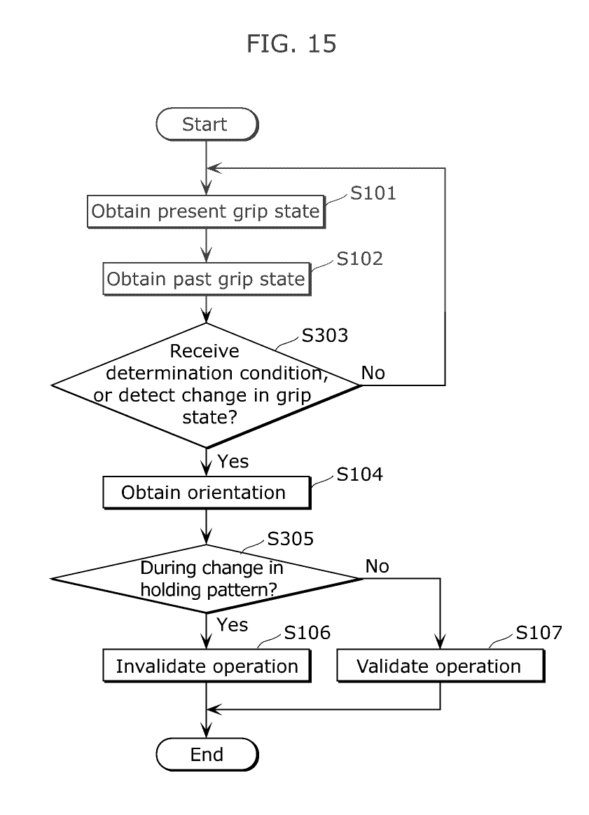

Embodiment 2 shows an example in which an incorrect operation is prevented by detecting a switch of an operation object by pressing down the switch 610 included in the input device 601 when the operation object is switched. In Embodiment 3, a display device transmits information about an operation object and a determination condition is switched for every operation object. With this, an incorrect operation can be prevented. Embodiment 3 will be described hereafter with reference to FIG. 13, FIG. 14, and FIG. 15.

FIG. 13 is a schematic view showing an example of an input device and a display device according to Embodiment 3. In FIG. 13, the same reference signs are assigned to the same constituent elements as shown in FIG. 1, and a description thereof is omitted.

An input device 901 includes, as similarly to the input device 101 shown in FIG. 1, two touch sensors (the left touch sensor 102L and the right touch sensor 102R), the grip sensor (not illustrated in FIG. 13), and the acceleration sensor (not illustrated in FIG. 13). Furthermore, the input device 901 includes a receiving unit (not illustrated in FIG. 13) which receives information about an operation object from a display device 1001.

As similarly to the display device 301 shown in FIG. 1, the display device 1001 obtains, based on a signal indicating a position notified by the input device 901, position information about a point at which the left finger 201L is touching the left touch sensor 102L and position information about a point at which the right finger 201R is touching the right touch sensor 102R. Then, the display device 1001 displays the left cursor 303L and the right cursor 303R, respectively, on positions within the display screen 302 that are corresponding to the obtained position information.

Moreover, a user operates the left cursor 303L displayed on the display screen 302 by moving the left finger 201L on the left touch sensor 102L. Then, the user operates the right cursor 303R displayed on the display screen 302 by moving the right finger 201R on the right touch sensor 102R.

A left half of a coordinate system of the entire screen display 302 is associated with a coordinate system of the left touch sensor 102L through absolute coordinates. A right half of a coordinate system of the entire screen display 302 is associated with a coordinate system of the right touch sensor 102R through absolute coordinates.

Furthermore, the display device 1001 includes a transmission unit (not illustrated in FIG. 13) to transmit, to the input device 901, information about an application that is an operation object.

Moreover, in FIG. 13, an orientation of the input device 901 which is not appropriate for operation is displayed on top right of the display screen 302. In this way, the display device 1001 may display an appropriate orientation of the input device 901 or an inappropriate orientation of the input device 901 on the display screen 302 according to an operation object.

FIG. 14 is a block diagram showing an example of configurations of the input device 901 and the display device 1001 shown in FIG. 13. In FIG. 14, the same reference signs are assigned to the same constituent elements as shown in FIG. 3 or FIG. 13, and a description thereof is omitted.

An operation control device 920 shown in FIG. 14, different from the operation control device 120 shown in Embodiment 1, includes a determination condition receiving unit 914. Moreover, operation is changed at a holding pattern determination unit 907. Furthermore, the display device 1001 includes an operation object switching detection unit 1012, a determination condition storage unit 1011, and a determination condition transmission unit 1013.

The display device 1001 switches an operation object such as an application program displayed on the display screen 302 in response to a request from the input device 901 and the like.

The operation object switching detection unit 1012 detects a switch of an operation object. Moreover, the operation object switching detection unit 1012 obtains a determination condition corresponding to an operation object from the determination condition storage unit 1011.

The determination condition storage unit 1011 is a storage unit which stores a determination condition. Examples of a stored determination condition are the determination condition 401 shown in FIG. 4, the determination condition 701 shown in FIG. 11, and the like.

The determination condition transmission unit 1013 transmits, to the input device 901, a determination condition corresponding to an operation object obtained from the determination condition storage unit 1011.

The determination condition receiving unit 914 receives a determination condition transmitted from the display device 1001. Then, the determination condition receiving unit 914 notifies the holding pattern determination unit 907 of the received determination condition.

The holding pattern determination unit 907 determines a present operation state of the input device 901 when the grip state change detection unit 105 detects a change in grip state or when the determination condition receiving unit 914 receives a determination condition. At this time, the holding pattern determination unit 907 determines the present operation state of the input device 901 according to a grip state detected by the grip state detection unit 103 and an orientation detected by the orientation detection unit 106. Then, the holding pattern determination unit 907 notifies the operation control unit 108 of the determined operation state. A method of determining an operation state of the input device 901 will be described in detail later with reference to FIG. 15.

FIG. 15 is a flowchart showing an example of operation of the operation control device 920 shown in FIG. 14. In FIG. 15, the same reference signs are assigned to the same processes as shown in FIG. 6 or FIG. 12, and a description thereof is omitted.

As shown in FIG. 15, operation in which the grip state detection unit 103 obtains a present grip state is similar to operation of Embodiment 1 shown in FIG. 6 (S101). Moreover, operation in which the grip state change detection unit 105 obtains a past grip state from the grip state storage unit 104 is similar to operation of Embodiment 1 shown in FIG. 6 (S102). Moreover, operation in which the orientation detection unit 106 obtains an orientation is similar to operation of Embodiment 1 shown in FIG. 6 (S104). Moreover, operation in which the operation control unit 108 controls an input signal according to an operation state is similar to operation of Embodiment 1 shown in FIGS. 6 (S106 and S107).

The holding pattern determination unit 907 according to Embodiment 3 determines whether or not the user is changing in a holding pattern of the input device 901 when a change in grip state is detected and when the determination condition receiving unit 914 receives a determination condition.

Therefore, when the determination condition receiving unit 914 receives a determination condition (Yes in S303), the orientation detection unit 106 obtains an orientation of the input device 901 (S104).

Then, the holding pattern determination unit 907 determines, based on a determination condition received by the determination condition receiving unit 914, whether or not a combination of a grip state and an orientation corresponds to a predetermined combination indicated by the received determination condition. With this, it is determined whether or not the user is during a change in a holding pattern of the input device 901 (S305).

For example, there is a case where the user switches an operation object such as an application program by using the input device 901. Then, there is a case where an appropriate grip state and an appropriate orientation are different for every operation object. Therefore, the display device 1001 holds in advance a determination condition corresponding to an operation object in the determination condition storage unit 1011. Then, the display device 1001 detects a switch of an operation object and transmits a determination condition corresponding to the operation object.

Then, the holding pattern determination unit 907 can appropriately determine, for each operation object, whether or not the operation state is during a change in a holding pattern by using a determination condition received from the display device 1001.

Moreover, when the operation object is switched, the determination condition receiving unit 914 receives a determination condition. When the operation object is switched, it is high likely that a holding pattern of the input device 901 is changed. Therefore, when the determination condition receiving unit 914 has received a determination condition, the holding pattern determination unit 907 determines whether or not the user is changing a holding pattern of the input device 901, with the result that the operation is controlled at an appropriate timing.

A sequence of processes shown in FIG. 15 is almost the same as that shown in FIG. 12, and a description thereof using a specific example is omitted.

### Embodiment 4

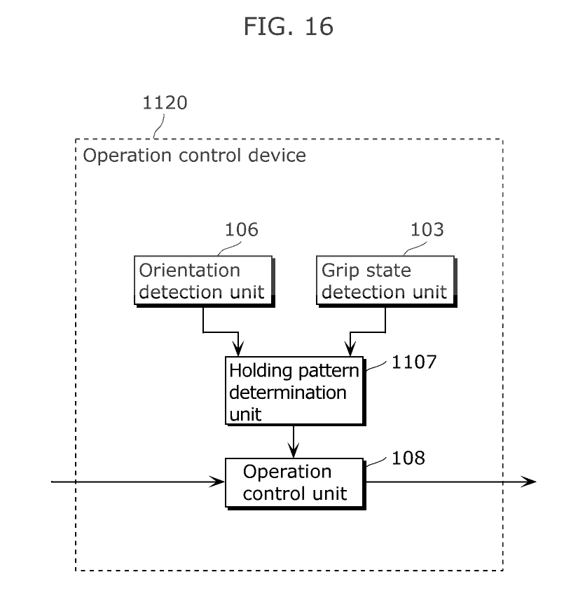

FIG. 16 is a block diagram showing an example of a configuration of an operation control device according to Embodiment 4.

An operation control device 1120 shown in FIG. 16 includes the grip state detection unit 103, the orientation detection unit 106, a holding pattern determination unit 1107, and the operation control unit 108. The operation control device 1120 is typically incorporated into an input device.

The grip state detection unit 103 detects a grip state which is a state in which a user is holding the input device.

The orientation detection unit 106 detects an orientation of the input device.

The holding pattern determination unit 1107 determines whether or not the user is during a change in a holding pattern by determining whether or not a combination of a grip state and an orientation corresponds to a predetermined combination. In other words, the holding pattern determination unit 1107 uses the predetermined combination as the determination condition shown in Embodiment 1 and the like.

The predetermined combination includes (i) a combination of a state in which the user is holding the input device with one hand and an orientation which is not suitable for operation with one hand, (ii) a combination of a state in which the user is holding the input device with a right hand and an orientation which is not suitable for operation with a right hand, (iii) a combination of a state in which the user is holding the input device with a left hand and an orientation which is not suitable for operation with a left hand, and (iv) a combination of a state in which the user is holding the input device with both hands and an orientation which is not suitable for operation with both hands.

Moreover, for example, when the input device is formed in a configuration having a longer side, the predetermined combination may be a combination of a state in which the user is holding the input device with one hand and an orientation in which the longer side of the input device is in a horizontal orientation (horizontal direction) with respect to a gravity direction. Moreover, when the input device is formed in a configuration having a longer side, the predetermined combination may be a combination of a state in which the user is holding the input device with both hands and an orientation in which the longer side of the input device is in a vertical orientation (vertical direction) with respect to a gravity direction.

Moreover, for example, when an input device is the input device 101 shown in FIG. 1, the predetermined combination may be a combination of a state in which the user is holding a right side of the input device 101 with a left hand and an orientation in which the input device 101 is in a horizontal orientation. Moreover, when an input device is the input device 101 shown in FIG. 1, the predetermined combination may be a combination of a state in which the user is holding a left side of the input device 101 with a right hand and an orientation in which the input device 101 is in a horizontal orientation.

The holding pattern determination unit 1107 determines that the user is changing a holding pattern of the input device when a combination of a grip state and an orientation corresponds to the above mentioned predetermined combination. Here is shown an example in which it is determined as during a change in a holding pattern in the case of corresponding to the predetermined combination, but it may be determined as not during a change in a holding pattern in the case of corresponding to the predetermined combination. Moreover, the number of the predetermined combination may be one or more than one.

The operation control unit 108 invalidates an operation inputted into the input device when it is determined that the user is changing in a holding pattern of the input device. Moreover, the operation control unit 108 validates an operation inputted into the input device when it is determined that the user is not changing a holding pattern of the input device.

With this, the operation control device 1120 prevents an incorrect operation during a change in a holding pattern of the input device. As shown in the operation control device 1120 in Embodiment 4, there may be not the grip state storage unit 104 and the grip state change detection unit 105 shown in Embodiment 1.

Although the operation control device according to the present invention is described based on the plurality of embodiments, the present invention is not limited to these embodiments. Modifications resulting from various modifications to the embodiments that can be conceived by those skilled in the art are intended to be included in the scope of the present invention. Moreover, other modifications realized by optionally combining the constituent elements of the embodiments are intended to be included in the scope of the present invention.

Moreover, the present invention can be implemented not only as the operation control device but also as a method including, as steps, processing units included in the operation control device. For example, the steps are executed by a computer. The present invention can be realized as a program for causing a computer to execute the steps. Furthermore, the present invention can be realized as a computer-readable recording medium on which the program is recorded such as CD-ROM.

Moreover, the constituent elements as illustrated in FIG. 3, FIG. 10, FIG. 14, and FIG. 16 may be configured as Large Scale Integration (LSI) that is an integrated circuit. These constituent elements may be individually integrated into one chip or part or all of the constituent elements may be integrated into one chip. Although the LSI is mentioned here, an integrated circuit may be called Integrated Circuit (IC), system LSI, super LSI, or ultra LSI depending on a difference in the degree of integration.

Moreover, the method of circuit integration is not limited to an LSI, and implementation with a dedicated communication circuit or a general-purpose processer is also available. A Field Programmable Gate Array (FPGA) which allows programming or a reconfigurable processor which allows reconfiguration of the connections and settings of the circuit cells inside the LSI may also be used.

Furthermore, if an integrated circuit technology that replaces LSI appears through progress in semiconductor technology or other derived technology, that technology can naturally be used for an integration of the constituent elements included in the operation control device.

Moreover, among the constituent elements of the display control device, only the unit which stores data may have a different configuration without being integrated on one chip.

### INDUSTRIAL APPLICABILITY

The operation control device according to the present invention can be used in various devices, such as a television (TV) receiver or a computer system, in which an operation is inputted by a grippable input device.

### REFERENCE SIGNS LIST

101, 601, 901 Input device
102L Left touch sensor
102R Right touch sensor
103 Grip state detection unit
104 Grip state storage unit
105 Grip state change detection unit
106 Orientation detection unit
107, 607, 907, 1107 Holding pattern determination unit
108 Operation control unit
109 Operation output unit
115 Operation input unit
120, 620, 920, 1120 Operation control device
201L Left finger
201R Right finger
301, 1001 Display device
302 Display screen
303L Left cursor
303R Right cursor
401, 701 Determination condition
610 Switch
611, 1011 Determination condition storage unit
612, 1012 Operation object switching detection unit
914 Determination condition receiving unit
1013 Determination condition transmission unit

1. An operation control device which controls an operation inputted into a grippable input device by a user, said operation control device comprising:
a grip state detection unit configured to detect a first grip state which is a state in which the user is holding the input device;
an orientation detection unit configured to detect an orientation of the input device;
a holding pattern determination unit configured to determine whether or not the user is changing a holding pattern of the input device by determining whether or not a combination of the first grip state and the orientation corresponds to a predetermined combination; and
an operation control unit configured to invalidate the operation inputted into the input device when it is determined that the user is changing a holding pattern of the input device, and configured to validate the operation inputted into the input device when it is determined that the user is not changing a holding pattern of the input device.

2. The operation control device according to claim 1,
wherein said grip state detection unit is configured to detect, before detecting the first grip state, a second grip state which is a state in which the user is holding the input device,
said operation control device further comprises a grip state change detection unit configured to detect a change from the second grip state to the first grip state, and
said holding pattern determination unit is configured to determine whether or not the user is changing a holding pattern of the input device when the change is detected.

3. The operation control device according to claim 2,
wherein said holding pattern determination unit is configured to determine whether or not the user is changing a holding pattern of the input device when an amount of the detected change is greater than a predetermined amount.

4. The operation control device according to claim 2, further comprising
a grip state storage unit configured to store grip state information that is information indicating the detected second grip state,
wherein said grip state detection unit is configured to store the grip state information indicating the detected second grip state in said grip state storage unit, and
said grip state change detection unit is configured to detect the change from the second grip state indicated by the grip state information stored in said grip state storage unit to the first grip state detected by said grip state detection unit.

5. The operation control device according to claim 1,
wherein said holding pattern determination unit is configured to determine whether or not the user is changing a holding pattern of the input device by determining whether or not the combination of the first grip state and the orientation corresponds to the predetermined combination corresponding to an operation object operated by the operation inputted into the input device.

6. The operation control device according to claim 5,
wherein said holding pattern determination unit is configured to determine whether or not the user is changing a holding pattern of the input device by determining whether or not the combination of the first grip state and the orientation corresponds to the predetermined combination corresponding to an application program that is the operation object.

7. The operation control device according to claim 5, further comprising
an operation object switching detection unit configured to detect a switch of the operation object,
wherein said holding pattern determination unit is configured to determine whether or not the user is changing a holding pattern of the input device when the switch is detected.

8. The operation control device according to claim 5, further comprising:
a determination condition storage unit configured to store the predetermined combination corresponding to the operation object; and
an operation object switching detection unit configured to detect a switch of the operation object, and configured to update the predetermined combination stored in said determination condition storage unit such that the predetermined combination corresponds to the operation object obtained by the switch,
wherein said holding pattern determination unit is configured to determine whether or not the user is changing a holding pattern of the input device by determining whether or not the combination of the first grip state and the orientation corresponds to the predetermined combination stored in said determination condition storage unit.

9. The operation control device according to claim 5, further comprising
a determination condition receiving unit configured to receive the predetermined combination corresponding to the operation object,
wherein said holding pattern determination unit is configured to determine whether or not the user is changing a holding pattern of the input device by determining whether or not the combination of the first grip state and the orientation corresponds to the predetermined combination received by said determination condition receiving unit.

10. The operation control device according to claim 9,
wherein said holding pattern determination unit is configured to determine whether or not the user is changing a holding pattern of the input device when the predetermined combination is received.

11. The operation control device according to claim 1,
wherein said holding pattern determination unit is configured to determine that the user is changing a holding pattern of the input device when the combination of the first grip state and the orientation corresponds to the predetermined combination of (i) a state in which the user is holding the input device with one hand and (ii) an orientation which is not suitable to operate the input device with the one hand.

12. The operation control device according to claim 11,
wherein said holding pattern determination unit is configured to determine that the user is changing a holding pattern of the input device when the combination of the first grip state and the orientation corresponds to the predetermined combination of (i) a state in which the user is holding, with the one hand, the input device formed in a shape of having a longer side and (ii) an orientation in which the longer side of the input device is horizontal with respect to a gravity direction.

13. The operation control device according to claim 1,
wherein said holding pattern determination unit is configured to determine that the user is changing a holding pattern of the input device when the combination of the first grip state and the orientation corresponds to the predetermined combination of (i) a state in which the user is holding the input device with a right hand and (ii) an orientation which is not suitable to operate with the right hand.

14. The operation control device according to claim 1,
wherein said holding pattern determination unit is configured to determine that the user is changing a holding pattern of the input device when the combination of the first grip state and the orientation corresponds to the predetermined combination of (i) a state in which the user is holding the input device with a left hand and (ii) an orientation which is not suitable to operate the input device with the left hand.

15. The operation control device according to claim 1,
said holding pattern determination unit is configured to determine that the user is changing a holding pattern of the input device when the combination of the first grip state and the orientation corresponds to the predetermined combination of (i) a state in which the user is holding the input device with both hands and (ii) an orientation which is not suitable to operate the input device with the both hands.

16. An operation control method of controlling an operation inputted into a grippable input device by a user, said operation control method comprising:
detecting a grip state which is a state in which the user is holding the input device;
detecting an orientation of the input device;
determining whether or not the user is changing a holding pattern of the input device by determining whether or not a combination of the grip state and the orientation corresponds to a predetermined combination; and
invalidating the operation inputted into the input device when it is determined that the user is changing a holding pattern of the input device while validating the operation inputted into the input device when it is determined that the user is not changing a holding pattern of the input device.

17. An integrated circuit for controlling an operation inputted into a grippable input device by a user, said integrated circuit comprising:
a grip state detection unit configured to detect a grip state which is a state in which the user is holding the input device;
an orientation detection unit configured to detect an orientation of the input device;
a holding pattern determination unit configured to determine whether or not the user is changing a holding pattern of the input device by determining whether or not a combination of the grip state and the orientation corresponds to a predetermined combination; and
an operation control unit configured to invalidate the operation inputted into the input device when it is determined that the user is changing a holding pattern of the input device, and configured to validate the operation inputted into the input device when it is determined that the user is not changing a holding pattern of the input device.

18. (canceled)

19. A non-transitory computer-readable recording medium having a program recorded thereon for causing a computer to execute the operation control method according to claim 16.

20. A grippable input device which controls an operation inputted by a user, said grippable input device comprising:
a grip state detection unit configured to detect a grip state which is a state in which the user is holding the input device;
an orientation detection unit configured to detect an orientation of the input device;
a holding pattern determination unit configured to determine whether or not the user is changing a holding pattern of the input device by determining whether or not a combination of the grip state and the orientation corresponds to a predetermined combination; and
an operation control unit configured to invalidate the operation inputted into the input device when it is determined that the user is changing a holding pattern of the input device, and configured to validate the operation inputted into the input device when it is determined that the user is not changing a holding pattern of the input device.
